(19) United States
(12) Patent Application Publication
(10) Pub. No.: US 2007/0033252 A1
(43) Pub. Date: Feb. 8, 2007

(54) Dynamic virtual network and method

(76) Inventor: Ricky F. Combest, Tualatin, OR (US)

Correspondence Address: BLANK ROME LLP, 600 NEW HAMPSHIRE AVENUE, N.W., WASHINGTON, DC, 20037, US

(21) Appl. No.: 11/581,044

(22) Filed: Oct. 16, 2006

Related U.S. Application Data
(62) Division of application No. 09/539,662, filed on Mar. 30, 2000.

(51) Int. Cl. G06F 15/16

(52) U.S. Cl. 709/204

(57) ABSTRACT

A system and method of operating hardware and services to allow participating members to find and establish partnerships, communicate, transact business and share information. The dynamic virtual network comprises the business exchange network, the network authority and the access device. The present invention employs the network authority, a neutral body regulating the trading partners and playing a passive role qualifying participating businesses, ensuring security and integrity, and guaranteeing non-repudiation of business transactions. The access device provides a number of services facilitating direct business-to-business relationships, communications, and transactions. The dynamic virtual network can also provide a set of services giving structure and organization beyond that of the public internet. These services enable participating businesses to find prospective partners, arrange partnerships, communicate with their partners, transact business and share information via the internet, exclusively among partners. The invention provides software and hardware to satisfy the specialized demands of business-to-business commercial transactions.

### BACKGROUND OF THE INVENTION

The present invention relates to a virtual network and more particularly to a private network operable over the public internet with enhanced reliability, security, uniformity and affordability.

The internet is a fertile area of commerce. Business conducted over the internet predominantly takes the form of business-to-consumer transactions. Electronic commerce between businesses, while also increasing, has experienced slower growth. The more gradual development of business-to-business commerce can be attributed to the unique needs of such transactions and business-to-business relationships.

Inter-business commerce demands greater security than commerce between businesses and personal users. Inter-business commerce requires secure communication and document exchange as well as certainty in party dealings. Organizations dealing at a distance run a greater risk of fraud than in face-to-face transactions. Businesses also run the risk of misdirected communications and miscommunication. Further, the potential for injury is much greater in a commercial transaction than in the typical consumer sale. A company must know the identity of the person with whom it is negotiating, that the other negotiator actually represents the second firm, what that person's role in that firm is, and whether that person is authorized to speak for the firm, enter into contracts or make other commitments on its behalf.

Significantly greater reliability is required by businesses expending large amounts of capital or establishing long-term contracts over the internet than by personal consumers. The nature of such inter-business transactions places unique demands on the internet communication and transmission structure. Typically higher levels of service are required by businesses than by consumers. The general use of the internet inevitably inflicts upon it undesirable “traffic jams,” wherein abnormally high use impedes smooth transmission. Communications must be ensured high-priority transmission to insulate them from the impact upon the internet of popular social, political or entertainment events.

An additional concern is organization of a network for inter-business commerce. Member information must be uniformly composed and orderly presented to facilitate business-to-business searches. The internet lacks an organizational scheme that can be effectively utilized in a business model. Searching is generally based on words and phrases found in published contents of a web site or in a web page's “meta” field (fields that describe the web page). Firms require the ability to search for potential trading partners, whether the searcher is offering its own product or seeking a particular item. Searches must allow this broad functionality; that is, whether the target partner is one offering a specific good or one evidencing a particular purchase need or habit. Searching must obviously permit a variety of selection criteria. Searches should be enabled on the bases of product, service, initial unit price, location or other pertinent factors. These kinds of searches require access to information seldom published by firms. They also require structural and functional forms of information that conventional web sites do not support.

Businesses currently undertake one of two basic approaches to deliver business-to-business commerce applications over the web. One approach, which can be called “web-based”, borrows techniques and features from successful business-to-customer applications and imports them to the business-to-business space. The web-based business-to-business model is typically based on a central sever which provides portal services focused on a specific niche vertical market. The second approach, which can be referred to as “supply-based”, uses methods learned from supply chain models and adapts them to the web. Supply-based solutions tend to reflect a hub-and-spoke architecture with a consumer company at the hub and one or more suppliers at the spokes.

Companies have attempted to satisfy some of these needs through traditional extranets (FIG. 1). The extranet 100 is a network physically independent of the public internet 101 and connects specific members, generally a primary business 102 and secondary service providers 103, 105. The members are connected in a closed network 100, permitting communications 110 within the extranet but not to the greater internet community 101. Security, reliability and speed of communication are addressed through the extranet's closed architecture. This architecture typically follows a hub-and-spoke model, in which a large company provides a server as the hub, with multiple spokes connecting suppliers, customers, and business partners to the hub. The extranet option is generally chosen by large companies, who form their own networks to connect their suppliers and business partners together. The network itself becomes a part of their enterprise system.

Extranets typically require an extensive amount of customized software because of their individual nature—an organization cannot order a ready-made extranet. Extranets provide high security and reliable, efficient communications among the connected members. However, extranets usually require expensive equipment: high bandwidth frame-relay lines, dedicated lines, routers and other equipment. Further, a skilled support staff is needed to support the extranet—software engineers to produce the software, network engineers to establish the network, and operations personnel to keep the extranet operating properly. As a result of the closed architecture and the major investment of financial and human resources, any alterations (changes, additions or deletions) to the system are very expensive. Implementing change will also be slow due to the organizational inertia. Typically, companies will have put millions of dollars per year in capital, engineering and technical resources investments into their extranets, further complicating the model and reducing its flexibility.

Another problem with this supply-based business-to-business approach is that it maintains nearly exclusive focus on the company with little or no recognition or definition of the individual members of the company. This focus is well-suited to operations where automated connections between two partner companies' Electronic Data Interchange (EDI) are the goal. Little or no recognition is paid to the needs of individuals within multiple departments of partner companies to communicate and execute legal documents. Further, the supply-based approach is founded on the assumption that a partner relationship is already in place between the two companies. No tools exist in these systems to locate and contact new partner companies internal or external to the membership pool. Security is entirely company-based with no individual partner-to-partner validation or authentication.

Another solution that has developed is the virtual private network (VPN) (FIG. 2). A VPN 200 connects a business and its partners using a simpler system than an extranet. The VPN is essentially a hybrid of the public internet 101 and an extranet 100, in which a corner of the internet 101 is effectively cordoned off. The VPN members 201, 203, 207, 208 reside in a private network of computers at least partially connected by public phone lines 209. Members connect to the virtual private network by means of VPN appliances 211. Public internet users 202, 204, 205, 206, lacking specialized hardware and software found in intranet servers and the VPN appliance 211, can access the internet 101 through traditional connections 210 but are denied access to the VPN. There is less customized software in a VPN than an extranet, because it uses the public internet as its backbone. This reliance on the internet has the advantage of more common software, aiding but not guaranteeing compatibility. However, VPN members must employ customized network software applications to conduct business over the VPN, e.g., encryption and protocols like Point-to-Point Tunneling Protocol to ensure secure transmissions of data packets. VPNs have lower communication costs that extranets—due to the use of public access internet lines—but the network still must be customized for each company that is trying to set up its own hub-and-spoke model. Each firm joining a virtual private network must make its intranet server compatible with the software and hardware requirements of the VPN. Further, each VPN can differ from other VPNs depending on the brand of equipment or software used. One VPN is generally not immediately compatible with another VPN, limiting the dynamic capacity of the networks.

A virtual private network still carries high capital and technical expertise requirements—hundreds of thousands to millions of dollars in capital and labor resources. While this investment is less than that required for an extranet, it is not a cost easily shouldered by a medium-sized or small business.

The broad deficiency in the web-based approaches is their spotlight on the individual, with little or no recognition of the company to which the user belongs. This individual user focus, while making membership administration easier and less costly, limits the total information value of the business-to-business environment. A user can poll for all the information contained on the portal server but cannot easily query the system for specific information regarding all member companies or their products. Further, this model lacks the structure to help one VPN business member find a second business if the second business is not connected to the first business's VPN. The web-based system provides a good method for partners to discover each other. It fails, however, to provide tools for creating relationships in a legal sense. Even if a partnership could be arranged, little if any support is provided for transacting Electronic Data Exchange. Security in most web-based systems is either minimal or based on secure channels between the portal and the user. As a result of their central server architecture, web-based systems also put sensitive company information under the control of the portal's operations group. Most company information systems or information technology directors find external control of this sensitive information risky and undesirable.

Because VPNs rely on the internet as their backbone, they are subject to outages and slowdowns in transmission. When part of the public internet goes out, businesses can suffer enormous injury to their balance sheets and reputations. For example, the Dec. 6-7, 1998 eBay® (<www.ebay.com>) auction site malfunction was estimated to have cost that company in excess of $20 million per hour. A VPN using the internet has no guarantee that it will receive a business-critical level of service.

Both the web-based model and the supply-based model fail to provide a sufficiently fertile and capable environment to replace activities currently undertaken by most businesses through telephone, fax, email and direct meetings. Both of the above approaches fail to recognize the importance of common and consistent definitions of companies as business entities and, more specifically, of individual users as employees of those companies. Neither approach recognizes that individual users serve roles within a company operation, that those roles carry certain rights and authorities, or that the execution of some roles carry legal implications. Neither approach offers itself as a neutral third party to support non-repudiable transactions between partner members while letting partner members retain control of their sensitive, confidential information.

Accordingly, it would be useful to provide an inter-business network offering companies consistent and secure transmissions, the ability to find new trading partners through common language and search protocols, and assurance of compatibility of hardware and software with those potential new members. Such a network capability should preferably be available at sufficiently low cost to place it within the reach of a broad range of firms.

### SUMMARY OF THE INVENTION

A Dynamic Virtual Network, according to the present invention, overcomes the problems and limitations of the prior art, remedying many of the deficiencies of the web-based and supply-based approaches. The present invention provides services and common definitions describing companies, their products and services, the individuals working for the company and the roles the individuals fill as representatives of the company. Utilizing common definitions and inter-related tools, company representatives can freely and with increased efficiency search out new business opportunities and form new partnerships. Recognition of organizations' individuals and their roles within organizations permits the Dynamic Virtual Network to provide tools to aid in person-to-person and person-to-company communications through methods more efficient than telephone, facsimile machine or traditional email. By employing definitions of individuals' roles, representatives of partner companies are able to execute legal, non-repudiable transactions, secure in the knowledge that both parties are authorized to execute such transactions.

Generally, the present invention provides a system of hardware and services, and a method of operation, allowing every participating member to find and establish partnerships, communicate, transact business and share information in a virtual private network operating over a public network such as the internet (FIG. 3). The invention also permits the on-line membership to be administered without impairing network operation, such that members may be added to or removed from the virtual network “on the fly” or dynamically, without disruption of services to existing members. The present invention provides software and hardware to satisfy the specialized demands of business-to-business commercial transactions. It builds upon available hardware and software, requiring no technically trained staff to install or maintain, and maximizes compatibility between existing and new network members. The invention can guarantee business-critical levels of service over high-level internet service provider (ISP) lines for rapidity and reliability. Access to the dynamic virtual network is affordable to a broad range of business sizes.

The dynamic virtual network operates as a business exchange, facilitating trading between member businesses within the network. The DVN preferably includes a business exchange network authority (BENA), which is a neutral authority acting to regulate the trading partners and playing a passive role as the authority over the business exchange. The BENA implements security and integrity and also supports non-repudiation of business transactions. The BENA acts as a central repository for non-repudiable business transactions that would serve as the evidentiary basis for resolution of any disputes arising between trading partners. The BENA also acts as the central authority for digital certificates and signatures. The dynamic virtual network can also provide a set of services giving structure and organization beyond that of the public internet. These services enable users in participating businesses to find prospective partners, arrange partnerships, communicate with their partners, transact business and share information. These concepts are presented to the member businesses in a very simple fashion, so that any size of business can become a participant in this dynamic virtual network. Cost is greatly reduced by use of the internet and the installation of only minimal, remotely-maintained software and hardware.

The foregoing and other objects, features and advantages of the invention will become more readily apparent from the following detailed description of a preferred embodiment, which proceeds with reference to the drawings. In the detailed description to follow, terms such as “manager” and “member” refer to software and/or hardware components of the system.

### BRIEF DESCRIPTION OF THE DRAWINGS

FIG. 1 is a representation of a traditional extranet.

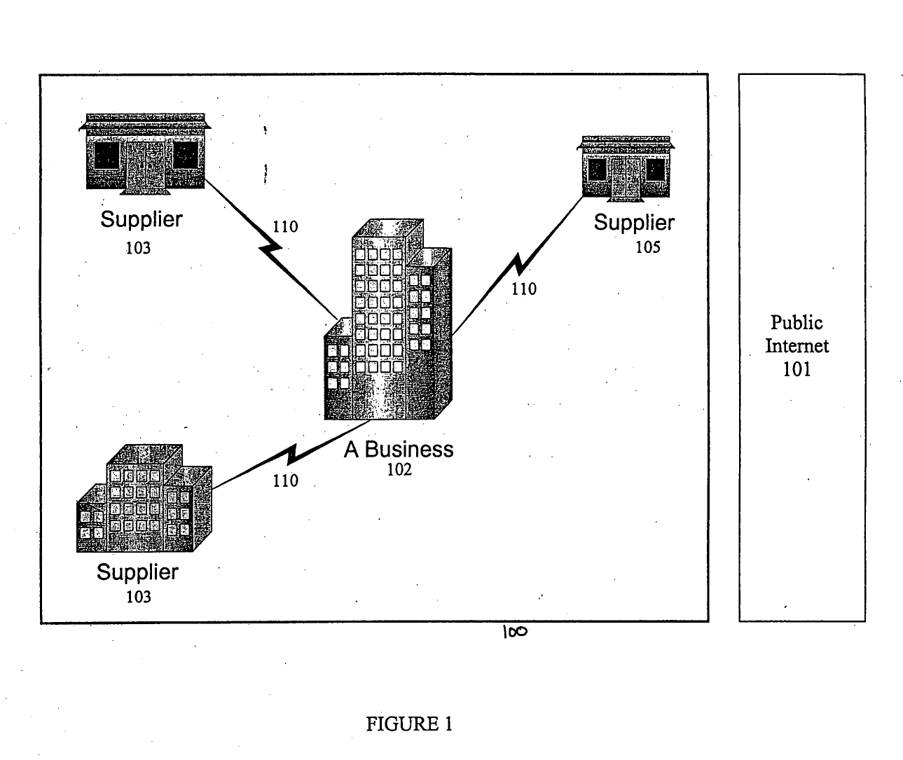

FIG. 2 shows a conventional virtual private network, in which a business and three suppliers are connected to the host business through the public internet via VPN devices.

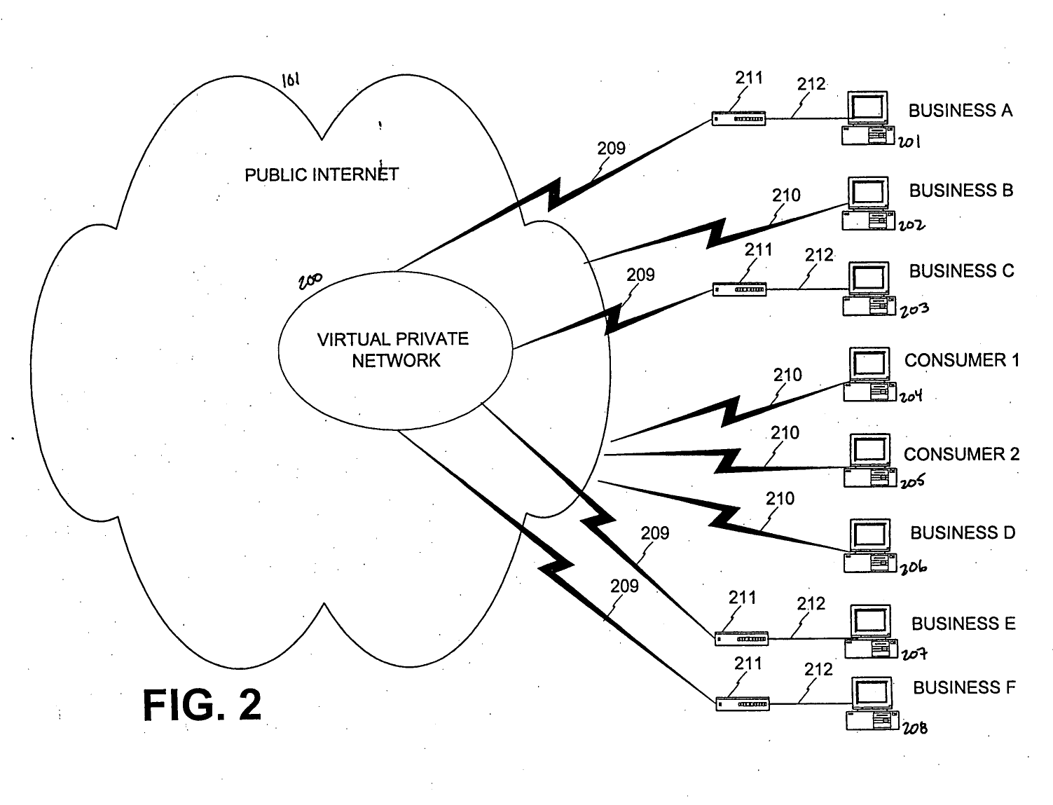

FIG. 3 is a diagram of a dynamic virtual network according to the invention, in which two or more businesses are subscribed under the auspices of a BENA and interconnected via the BNADs that facilitate business-to-business communication and information services.

FIG. 4 illustrates in more detail the overall relationship of the components of the dynamic virtual network of FIG. 3.

FIG. 5 depicts the software architecture of the dynamic virtual network's BNAD.

FIG. 6 portrays the stepwise process through which a one DVN member finds a potential partner according to the invention.

FIG. 7 shows the process by which a business partnership relationship is established between two DVN members according to the invention.

FIG. 8 illustrates a sample transaction, and the contemporaneous non-repudiation process, between DVN business partners according to the invention.

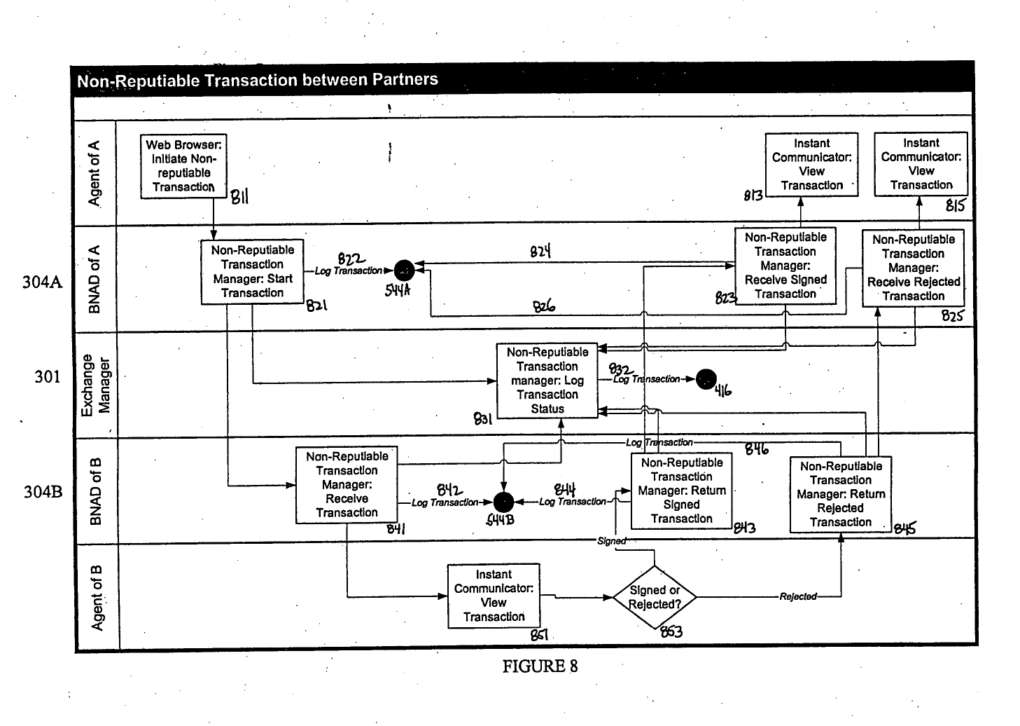

### DETAILED DESCRIPTION

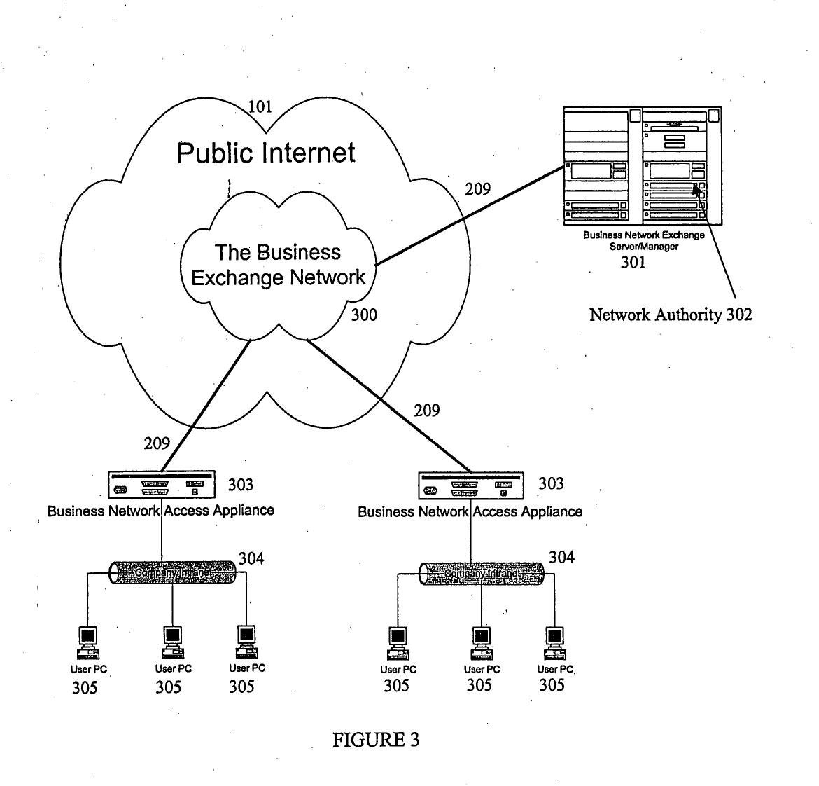

Referring to FIG. 3, the dynamic virtual network (DVN) operates as a private network within the public internet backbone 101. Businesses typically require higher levels of internet service provision than do general consumers. The DVN is part of the public internet, albeit a regulated part. The DVN preferably uses service level agreements to secure for itself business-critical levels of quality. Using the highest tier ISPs, the network can be guaranteed high priority access to meet required levels for speed and reliability. The idea behind privatizing part of the public internet is to guarantee this business-critical level of service.

The DVN will be built on only highest-tier internet providers. In order to get the level of service needed for business-critical information, the ISPs must isolate business-critical traffic from routine internet traffic. Even though traveling over the same backbone, the highest-tier providers are able to prioritize traffic such that businesses can be given priority. In this way, businesses are shielded from the uncertainties of public network outages and slowdowns. In this business network, the traffic is prioritized. Even when social, political or entertainment events captivate the general internet user pool, business traffic can continue unhindered by any kind of service disruption.

Qualifying ISPs must provide a compatible quality of service in order to be an approved DVN ISP. Top-tier ISPs will move higher priority traffic to the top at any point along the line as an information packet is moving across the network. Prioritization of DVN transmissions is to be distinguished from preemption, in which a DVN message “bumps” a non-DVN message for transmission along the ISP lines. Prioritization guarantees that data get from point A to point B as expeditiously as possible. But ISPs are not required to dedicate lines for specific use only for the dynamic virtual network. The value of this prioritization is illustrated in the discussions of the preferred embodiments, infra.

To become a service provider on the dynamic virtual network, an ISP must also meet required service levels for speed, reliability and performance. Information going from point A to point B must make that journey within a brief, guaranteed maximum amount of time. Also, the DVN can guarantee to its members that communications and transmissions will occur and at no lower than a specified minimum speed. By using a plurality of ISPs, the DVN assures unimpeded transmissions. If any one ISP should become isolated on the internet and lose the ability to send or receive data, the DVN shifts its messaging to the remaining ISP channels without incident. Member businesses can conduct their dealings with third parties without-concern for transmission speed or certainty.

Referring to FIG. 3, the dynamic virtual network (DVN) comprises the business exchange network (“network”) 300, the DVN server 301 housing the business exchange network authority (BENA) 302, business network access devices (BNADs) 303, and communications links 209 for connecting these elements over the global network 101. More specifically, the present invention employs the BENA 302 to qualify participating businesses 304, ensure security and integrity, and guarantee non-repudiation of business transactions. The BNAD 303 provides a number of services, in addition to basic VPN functions, that facilitate direct business-to-business relationships, communications, and transactions without having to pass through a host server, as in extranet systems.

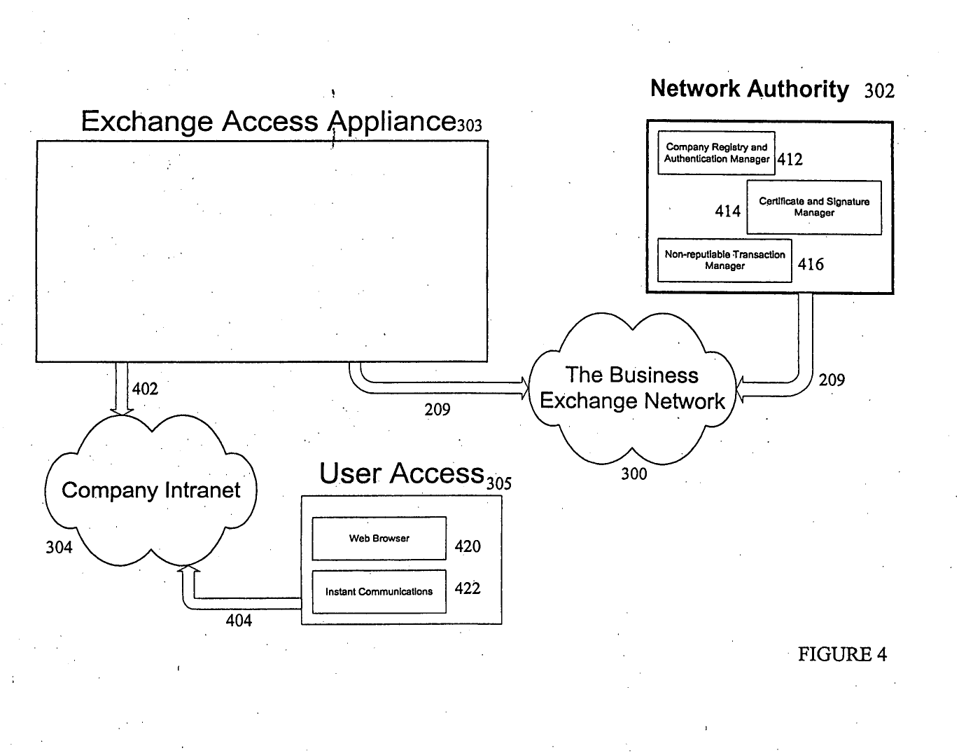

As illustrated in FIG. 4, there are two major software components of the dynamic virtual network, a BENA 301 and a BNAD 303, as well as an associated user access 304.

### Business Exchange Network Authority (BENA)

The BENA 301, or Exchange Manager, acts as a regulating authority implemented on a server. One role of the BENA is to authorize member businesses and certify their data. The BENA serves as the source for certificates, part of the public key infrastructure technology (discussed more fully below). Certificate management is a concern in a public key infrastructure. The BENA manages security certificates and, in doing so, manages security across the dynamic virtual network. The BENA qualifies businesses to become members on the DVN. This qualification can, for example, include review of a Dun & Bradstreet® report. The BENA also provides useful business-related content to member businesses through the businesses' computers. This function is a general informational part of the exchange, providing useful common information about member businesses to other users of the DVN.

Finally, the BENA 301 also serves as the central log for non-repudiable transactions, such as contracts or shipping orders. The BENA records and logs all non-repudiable transactions that occur on the exchange. The BENA acts as an independent repository for transactions to aid in resolving any disagreements that may subsequently occur between partners. The importance of these functions will be more fully discussed below.

The BENA is a server hosted in a secure location. Its function is to regulate the consistent operation of network services to the computer systems of businesses qualified as members of the DVN, i.e., the network members. The BENA provides three primary services: company registration and authentication 412, certificate and signature management 414 and non-repudiable transaction management 416.

The Company Registry and Authentication Manager 412 is responsible for authenticating exchange businesses by confirming business certificates of authority. Only those businesses that have met specific qualification standards are allowed to access the DVN. In addition, the Company Registry tracks the internet and street addresses of each company as well as their on-line status.

The Certificate and Signature Manager 414 serves as a central repository for all digital and physical signatures assigned to entities within the exchange. Every entity—businesses as well as employees and agents of businesses having access to the exchange—has a unique digital signature assigned to it. With this data, the company that originated a transaction and also the exact person(s) and role(s) involved in the transaction can be tracked by the BENA and the transacting parties.

It is assumed that some agents will operate outside the DVN. In these cases an analog signature technology means (a current example of such technology would be that provided by PenOp™) can be used to collect, store and validate the physical signature.

The Non-repudiable Transaction Manager (NRTM) 416 is responsible for logging non-repudiable transactions between network members. A trace of each non-repudiable transaction is archived by the BENA and can be accessed for legal or private purposes.

### Business Network Access Device

The business network access device (BNAD) 303, or Exchange Access Appliance, controls access into the network. The BNAD is a self-contained device. While it can be an appropriately configured computer, the BNAD is preferably a simpler device housing the elements necessary for its target user, minimally a processor, memory and network interface together with the software and information needed to facilitate access of network members to other members while excluding access by network non-members.

The BNAD contains the certified business information and software necessary for a member business to access the DVN and support all the DVN services. A BNAD is delivered to an authorized member business and installed to connect the company's intranet to the dynamic virtual network. This installation can place the BNAD between the business's intranet server 304 and the global network 101. Alternatively, the BNAD can be connected between the intranet server and some or all of the member's individual users 305. The elements housed in a particular BNAD can be customized to the type of connection and elements already in place on the member's server. All certifications and supporting software applications are hidden behind an easy-to-use user interface. Essentially, a member's agents will operate on the DVN through a web browser-type interface and a communications application, together providing user access, with the DVN's functionality hidden within the BNAD.

The BNAD maintains the profile or description of the member business, its user roles, and its personnel data. This facility permits a level of organization greatly outstripping that offered by the public internet. Within the DVN, there is a common motif to the presentation of data representing the identity of each business and the goods and/or services offered by that business. The data for a particular member business are housed within its BNAD. These data can include critical information that a company would not make public, e.g. on its web site, but which is necessary to dealings between business partners. Critical information would include personnel at the member business, their roles within that business, their authority to transact and contractually bind the member business, and so on. Within each BNAD, particular user roles would also be described: the set of users or agents for that company; what rights those roles have within a business; what authority they wield; whether they can make new partnerships; and whatever powers and authority they might have.

Members looking for a particular type of good or service can easily search for an appropriate member business, with the potential to make them a new trading partner, by exploring the information displayed on each member's BNAD. In conducting such a search, the DVN offers the advantage over the internet that, for each organization, the organization's directory of goods/services and its information is presented by the DVN in a common fashion. This uniformity permits businesses to conduct electronic commerce more efficiently than the way in which inter-business commercial transactions are currently performed.

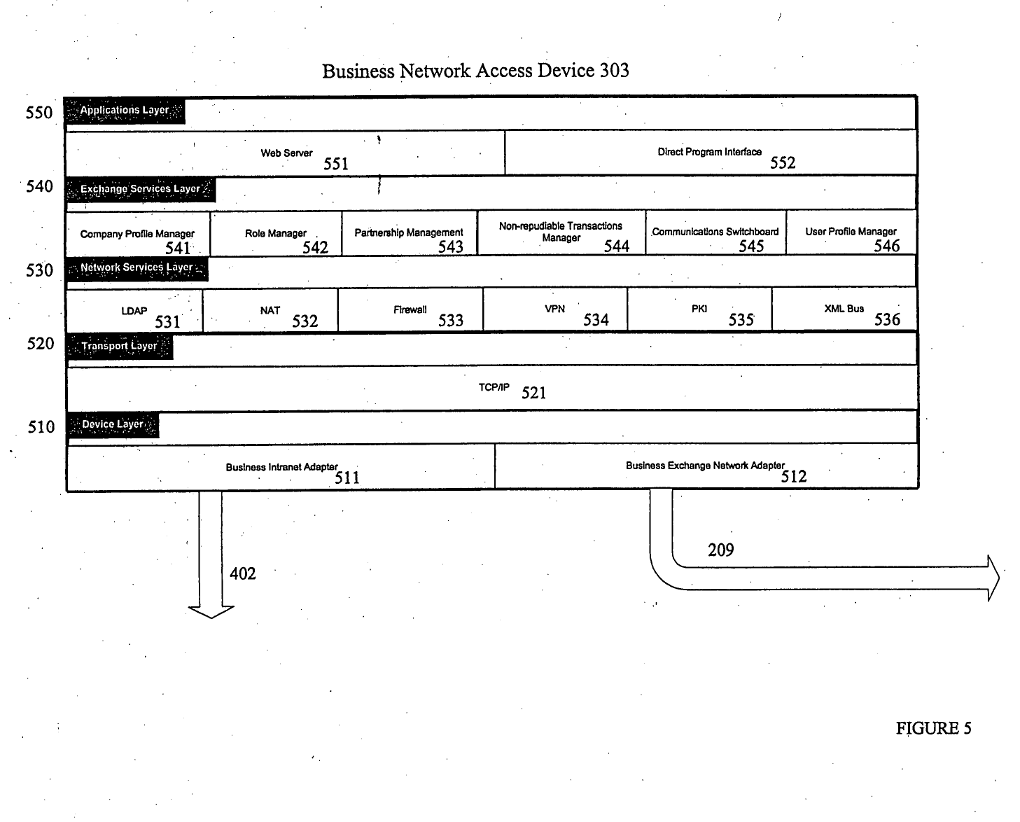

The preferred arrangement of the BNAD system 303 is presented as an open systems architecture diagram in FIG. 5. Each BNAD houses its software architecture:

A. Transport Layer 510 and Device Layer 520

These layers are provided by the operating system (preferably Linux or other open-source alternative). These two layers are standard capabilities of a system accessing the internet and are well-understood by those skilled in the art. TCP/IP allows computers to communicate over long distance networks. IP is responsible for moving packets of data between nodes, and TCP is responsible for verifying delivery from client to server. TCP/IP forms the basis of the Internet, and is built into nearly every modem operating system. A connection 209, which can be dial-up, digital subscriber line (DSL), cable modems, or T1 or equivalent high-bandwidth direct connections, is made from the DVN adapter 512 to the internet 101. The business intranet adapter 511 is implemented to functionally connect 402 the subscribed member's intranet to the BNAD.

B. Network Services Layer 530

Above the transport layer is a network services layer. DVN users do not directly interface with the network service applications.

1. Lightweight directory access protocol (LDAP) 531. LDAP is a standard for accessing shared information. A variety of incompatible systems may be used to store directories of information. Lightweight directory access protocol provides a simple and standardized protocol permitting access to and searching of these incongruent directories over a network connection.

2. Network address translation (NAT) 532. Network address translation (NAT) is a software package developed by the Internet Engineering Task Force (IETF) describing a standard method for bridging a company's local network to an external network. NAT automatically translates information or document requests from a user on one network to a second user on a different network.

3. Firewall 533. Firewall capability lowers the barrier to entry for small businesses, which need not buy a separate computer to shield their intranet from the public internet. This feature permits a business to control visitor access to its DVN presence.

4. Virtual Private Network 534. Another service in the network layer is the ability to create virtual private networks within this network. The VPN, as described above, is a protocol for establishing a network of nodes. The BNAD uses this element to establish the nodes of the dynamic virtual network.

5. Public key infrastructure 535. Public key infrastructure (PKI) is the certification element, enabling members to preserve the security of network communications and transactions. PKI is a standard method for implementing security across the network. Consisting of the digital certificates, certificate and registration authority, management services and directory services, the PKI component allows a digital certificate to be assigned to each valid user allowed to access the DVN through a company's BNAD. These components verify the identity and authority of each member transacting over the network. The certification authority issues and revokes digital certificates, binding a specified attribute to a public key. Certificates are bound to the hardware of the BNAD, preventing fraud by BNAD cloning. The PKI component also provides decryption ability to a member's partners, permitting them to read that member's confidential communications.

6. Extensible Markup Language (XML) bus 536. All transactions occurring over a business network will preferably be based on XML, a system for defining specialized markup languages used to transmit formatted data. In the preferred embodiment, XML is the common standard to be used for communicating information within the DVN. The XML bus is the transport mechanism for all objects carried on the DVN. This function, in the past called message-oriented middleware (MOM), provides the ability to manage messages between entities—for example, entities such as processes running on machines at different locations. In the past, communication between the two processes was accomplished with components such as remote procedure calls (RPC). RPCs, however, are expensive and slow. Message-oriented middleware is a more efficient means of communication between two separate processes. Instead of performing a remote procedure call, MOM is signaled and sends to the receiving process a command and the data in a message. The receiving process reads the message, performs a step, and sends the message back with the result. Additionally, MOM is less costly and easier to program than RPC.

Using the XML bus to perform MOM further enhances the functionality of MOM by providing a protocol capable of sharing more than a mere message. Additionally shared is a higher level understanding of the message. Such a higher level would include the messages' attributes and meta information—that is, information describing the content of each message. Examples of this in XML parlance are document type definitions (DTD), X-schema and resource definition framework (RDF).

With the “meta” capability of XML, one process can give another process a description of a document that will be sent and the properties and capabilities of that document. This document description lets the second process know what kind of document the process will receive and what to do with the document when it arrives. XML represents a very efficient way of moving information reliably through the network. In this way, businesses are assured that when they send a document, it will reach its destination and rapidly so.

A goal of the DVN is to match the communications performance of current business practices: facsimile transmissions and telephone conversations. The internet fails to provide certainty in communications, sometimes transmitting no message and other times inducing the sender to re-transmit, resulting in multiple messages. The XML bus will provide different levels of service for transmitting XML documents over the network. Each level will provide an increasing level of service. The layers include:
Guaranteed delivery—messages of this type are guaranteed delivery to the given recipient(s) within an allotted time, assuming a valid recipient and address. This delivery preference is analogous but superior to the express mail capability of the post office in terms of the latter's speed and high probability of delivery.
General delivery—messages are transmitted on a “best effort” basis with no guarantee of delivery. Email, chat text and instant messages are example uses of this type of service. This delivery setting is akin to sending certified mail through the post office.
Broadcast delivery—message is sent to all businesses whose BNADs are currently on-line.
   C. Exchange Services Layer 540

The exchange services layer is where the common functions of the present invention are implemented within the BNAD.

1. Company profile manager 541. One function of the exchange services layer is a company profile manager, which enables a business representative to manage the profile of the company. When the BNAD is built, the member business specifies a representative (hereinafter “administrator”) with authorization to access and modify the company data within the BNAD. The profile manager includes a set of tools that allow the administrator to describe the business in a standardized fashion. The company profile manager can also be configured to accept defaults from a third party, e.g., Dun and Bradstreet®. Each company profile can be rendered in RDF so that the information can be searched, sorted and displayed using an RDF-compliant web browser.

2. User profile manager 546. The user profile manager allows each user who has DVN access as a representative of the company to be described in the member business profile. For all user profiles, role assignments and sets of transactional and DVN access rights associated with that role are allocated. Each user profile can be rendered in RDF so that the information can be searched, sorted and displayed on RDF-compliant web browsers.

3. The role manager 542. The role manager, related to the company profile manager, provides a means of expressing organization within a company. Roles can represent company departments, such as Shipping/Receiving or Marketing, as well as the pertinent personnel hierarchy within a department. Roles need not be tied to particular personnel (users)—a role is a function or activity within a member business rather than a specific person or job title. Company users can be assigned one or more roles within a company. They can also be assigned varying rights and privileges depending on their roles. For example, one user might be permitted to oversee shipments of goods but not to form contracts for the shipment of goods. Another user in the company might possess the complementary roles and authorizations: the ability to enter into contracts but no oversight of the acts in performance. Roles may have overlapping authorities. This flexibility permits a member business to organize and present its authorized employees and agents and their roles as accurately as possible.

4. Partnership manager 543. The partnership manager is responsible for carrying out partnership arrangements that each company wishes to make. The partnership manager is responsible for manipulating software elements to permit businesses in a partnership arrangement to share data and encrypted communications as well as to transact. The partnership manager executes all of the required low level commands to set up firewalls, VPNs, NATs, LDAPs, PKIs, and other services of the network services layer to incorporate new business partners. The electronic partnership creation is performed in the background, allowing members to express, identify and categorize their partners in a customized, graphical fashion.

5. Non-repudiable transaction manager 544. Any transactions transmissions passing through the non-repudiable transaction manager are logged and recorded with the exchange manager. The non-repudiable transaction manager (NRTM) works to define forms with a forms definition tool and treats the form as a piece of paper. The NRTM exploits the PKI component 543 to neutrally archive and preserve communications comprising a business transaction. By using digital signatures, the non-repudiable transaction manager prevents parties from repudiating agreements. The non-repudiable transaction manager utilizes the XML bus 536 to carry out these actions.

6. Communications switchboard 545. The communications switchboard is the network equivalent of a company's private branch exchange (PBX), an in-house system interconnecting users to one another as well as to an external communications system. It functions similarly to a PBX in that it allows multiple users to be described in the DVN, recognizes users, recognizes a directory, and is capable of finding users, placing single or teleconference calls, delivering or forwarding messages, and so on. The switchboard is executable software whose settings the member can customize. This-customization makes the DVN more business-centric for each business.

The switchboard controls a company's communications with other companies, governing both instant messaging and e-mail access. As instant messaging and e-mail are merged, the DVN can continue to operate effectively. Every company requires a centralized way to manage communications. The switchboard, connected to the user profile manager, will serve that function. In the typical portal model, a large switchboard is located at the ISP site. Each member business is required to place its key data on the ISP server rather than maintaining the information on its own server. However, companies generally desire to retain their data on-site and maintain control of their own switchboards, allowing them to decide which users within the company are available for external communications and how those users are reached.

D. Applications Layer 550

Layered on top of all of these elements is the applications layer, making the BNAD components accessible through one of two applications. The first application is a web server component 551, serving these BNAD functionalities to standard browsers 420 and communication applications 422 operated by users at each business. The second application that can access the applications layer is a direct program interface 552. The direct program interface 552 allows any company to easily adapt their enterprise software to the DVN. The direct program interface defines the entry points of the software. The DVN provides interfaces to the other elements—the company profile, partnership manager, user profile, non-repudiable transaction manager, and communications switchboard.

### User Access

User access 305 is provided through any device that will support a standard XML-compatible web browser 420 and an instant communications application 422 and that offers means for a global network connection 210. The instant communications application 422 can process plain-text messages similarly to other industry standard communicators. The application accomplishes effectively instantaneous transmission of messages among a plurality of users. The instant communications application can handle XML documents. The application is also capable of understanding a business's partnership organization and allows documents to be directed at individual users or roles (within or exterior to the business), defined groups of users or to partners defined and managed by the partnership manager.

### FEATURES AND BENEFITS OF THE INVENTION

Features and benefits of the dynamic virtual network (DVN) include security, reliability, organized and uniform presentation of member information, archival of transaction transmissions, compatibility of hardware and software between member businesses, and low purchase and maintenance costs.

Qualification of member businesses. It is important for a transacting business to know both the role of the person on the other end and what authority have they been granted by their company. Such knowledge is necessary to promote trust and also to prevent the possibility of fraud. All businesses participating in the DVN are pre-screened and qualified. The qualification process ensures each network member that the DVN is a virtual community of legitimate business entities. Qualification generates the trust between businesses necessary for successful electronic commercial dealings. Certification, discussed more fully below, prevents disingenuous parties from passing themselves off as authorized officers or agents of a qualified member business. A fictitious company cannot be created and fraudulently placed on the DVN: the qualification and certification processes are designed to discover the falsehood.

Standard definition and access to business profile information. The internet lacks any standardized definition and access to business information and employee/agent roles. Such organized information is necessary to increase search efficiency. Because each member business is described in a standard way in the DVN, any member can easily search the network for another business having a particular feature. For example, a bicycle manufacturer producer may desire titanium screws for use in its bicycle equipment. The bicycle manufacturer can form an appropriate query, send it out to scan the information contained in each member's BNAD, and find every member business that might have what it seeks. The bicycle manufacturer can then contact the target bolt producers to contract with them or to invite them to bid on a particular proposal.

Specialized content. The sheer immensity of the internet's business population prevents data from being uniformly presented for all businesses. By providing categories and classifications, the DVN offers specialized searching using a comprehensive, verified and uniform set of criteria. Intrinsic to this uniformity of content is a “set and forget” capability, wherein a member business may define those goods or services in which they have an interest. When a BNAD comes on-line for a business offering the preferred goods/services, the member business instantly receives notification. Finding that the new member's data matches the criteria of the standing search, the new member's profile is forwarded to the search agent as a match. Conversely, a member business may set its appliance to send information on its own goods/services to any other member (current or future) whose profile indicates partnership potential. As BNADs come on-line for potential partners, the member business's BNAD discovers the new member. The search agent assesses the member's profile and finds that it meets the search criteria. Consequently, the searching member's goods/services information is sent to the new member. This feature aids businesses in finding and developing new partnerships.

Member control of sensitive business information. Companies want to control what information is made available to other businesses and the public. Each company prefers to retain control of its own information. A portal approach, where information is placed on a remote, centralized server, strips companies of this control. The internet permits businesses to retain full control over the information they display, but at the expense of a disorganized data presentation. The exchange services layer stores information about member businesses. Having profile data resident on the BNAD makes the DVN more business-friendly, with the BNAD contained locally at each business's site and under that business's control.

Transparent assignment and regulation of certificates of authority. In the current contracting model, parties transact via telephone, facsimile and perhaps the internet. Businesses dealing with a smaller or newer business—with a less established identity—face a greater risk of fraud. This risk is especially great in internet transactions, where the company may be located anywhere. It may be quite difficult to verify the identity or validity of a small/new business and its personnel. For all communicating entities on the DVN, certificates are issued to the company, its personnel, and its roles. As each business controls its internal profiles and user authorizations, the sender of a communication may be relied upon as possessing authority to carry out the transaction.

Non-repudiation of agreements. Non-repudiation relates to a party trying to back out of an agreed deal. The DVN provides ways of guaranteeing that a piece of information tagged with a certificate can be relied upon as originating from that business. Certificates are linked to each company's roles rather than its personnel. Attached to each communication, the certificate confirms that the sending role has actual authority to negotiate and agree to a deal. Personal digital signatures are also stored with the DVN, enabling similar verification of attached electronic signatures.

As well, the DVN archives transacting communications between parties. Electronic documents are easily altered. The terms of a wholly electronically-negotiated contract could ordinarily be changed with impunity by one party. The non-repudiation feature, resident in the BNAD and the BENA, archives a copy of every communication identified as a transaction document. This feature allows a business partner to electronically conduct negotiations, confident that both parties (and the network authority) possess identical and genuine copies of the negotiated agreement.

Instant multimedia communications. It is essential that companies transacting business communicate as quickly as possible. Communications travel time must be negligible, similar to telephone and facsimile. Internet communications, while occurring at high speed, lack the certainty that the message has been delivered to the intended recipient. In times of high internet activity, communications can be slowed or halted. The dynamic virtual network avoids these problems and allows instant communications between individual member businesses. This speed and certainty are achieved through the priority handling of information packets and high reliability guarantees of the ISPs over whose systems the DVN is placed.

Predefined sets of forms. Another feature is the inclusion of a standard set of forms for business transactions. These forms include basic contract templates, non-disclosure agreements, license agreements, and so forth. Members using these common forms can avoid contractual problems such as the “battle of the forms,” in which each party's contract contains fine print conflicting with the other party's language. The specific forms can easily be defined and allow a small business to participate in the DVN without the need for customized programming.

Forms designer and transaction definition toolkit. Alternatively, businesses can develop their own customized forms using a graphical interface tool. This toolkit permits a business to structure its deal-making process. For example, business A and consumer B negotiate a transaction. Business A then completes a customized form, requiring certain fields to be completed by consumer B, and transmits the form to consumer B. Consumer B then checks off and signs the form and returns it to business A. After business A signs the form, a binding contract is formed. This process could be described in this tool, allowing companies to develop their own transaction processes.

Member administration interface. The BNAD contains an administration interface that allows an information systems department or person within a member company to administer the system. This administrator can control the operation of network access, grant and deny rights to internal users, grant and deny access rights to business partners, and describe business relationships from one company to another. A simple interface is utilized, allowing the business to manage its data with no additional investment in software or personnel.

Compatibility between BNAD and third-party applications. An integration tool kit allows network members to integrate third-party applications into their dynamic network access device. This ability allows them to make improvements to their intranet or VPN without affecting their DVN subscription or performance.

Network based on industry standards. Events are standards-based in execution, rather than relying on proprietary protocols. The DVN is open to any available standard, allowing it to progress as improved software and hardware components become available. In particular, the stratified software structure within the BNAD and BENA permits flexibility in choosing each of the discrete elements.

### EXAMPLE USES OF THE INVENTION

Businesses can use the dynamic virtual network to transact business, find potential partners, make their information available to other network members and communicate exclusively with other network members. To preserve clarity, the human interaction has been excised by anthropomorphizing, where possible, the elements of the invention. The following examples are offered by way of illustration, not limitation.

### Example #1

### Subscribing to the Dynamic Virtual Network

Existing technology lacks the facility to connect a business on an existing virtual private network to another business that isn't on the same VPN. One of the problems with VPN is that the conventional VPN units have to match on each end. By embedding the VPN function in a network access device (BNAD), the invention overcomes this drawback.

A firm desiring membership in a dynamic virtual private network subscribes by first contacting the BENA. Required basic information about the prospective member is forwarded to the BENA. This information is then verified by the BENA, using supplementary data supplied by external sources, such as Dun & Bradstreet® or other information agencies.

After passing this verification step, the BENA loads this preliminary data and certifications into a customized BNAD, which is then shipped to the new member. The firm connects the BNAD to their existing public internet connection. When a BNAD comes on-line and communicates with the exchange server, the BENA validates that the appliance is allowed access into the DVN. The BENA checks the new member's certificate of authority—attached to the initial message—to verify that the connection and company identity are valid. The BENA also verifies the BNAD's pre-loaded company data against the data used in the qualification process. This verification step prevents spoofing or other fraud. For example, if a party attempted to fraudulently connect an impostor appliance identifying itself as, e.g., General Mills, when the BNAD contacts the BENA, the BENA would try to validate the imposter's certificates. The imposter would fail this validation check and imposter's network access would be suspended. This verification process occurs automatically at the software level via the interchange between the BENA and the BNAD.

### Example #2

### Defining the Business Presence

Once the BNAD is successfully on-line, a person designated as the administrator on the business side can begin setting up in-house user profiles. An initial company profile is set up based on the information provided by the company during the application phase. Once on-line, the business can add or modify this provisional information. This step can be performed from the company's internal network from a user terminal.

The administrator uses the applications level—the web server and direct program interface—to input data to the company profile manager and role manager. A distinction between the company user information and role information is that the company profile is displayed to all network members. On the other hand, role information is generally only used internally and in member-to-member communications, e.g., between business partners or a seller and buyer. As mentioned previously, this method provides member businesses control over the security of their internal, proprietary information.

Company profile data includes, for example, product and service information, standard pricing and shipping terms. Role information defines the identity and authority of each contact person within the company. Authorities include the ability to perform various tasks such as responsibility for certain products, services, regions, or customer categories; tracking; customer service; transacting; and contract execution.

### Example #3

### Finding a Potential Partner

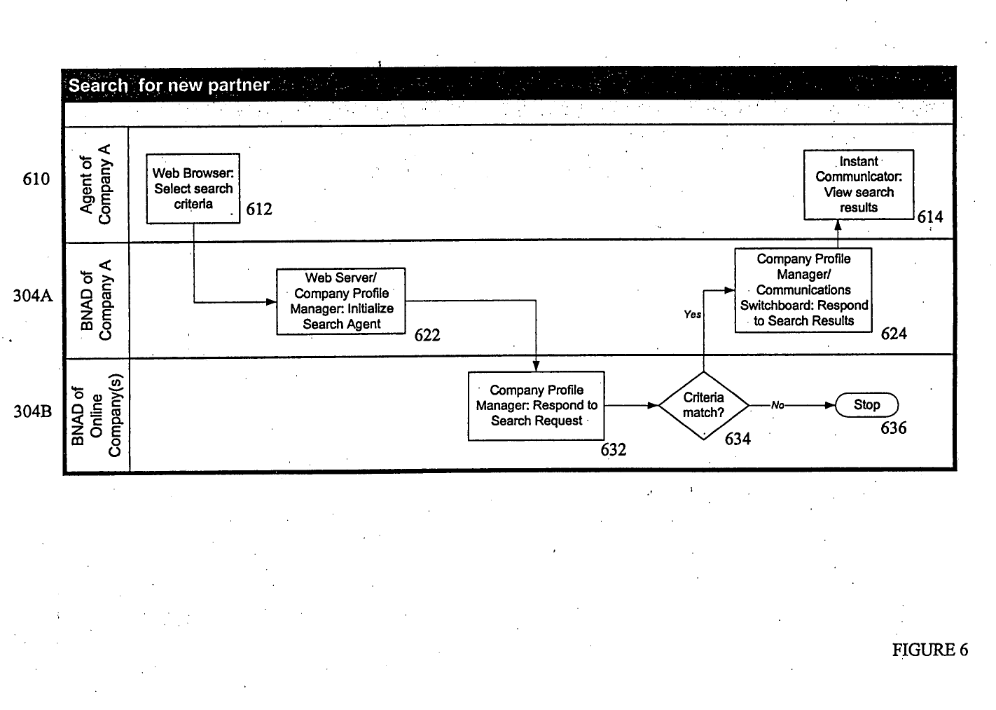

After two or more businesses are on the network, the DVN enables them to find one another based on any factors of their choosing (FIG. 6). For example, assume Buyer 610 is an aircraft manufacturer in need of FAA-approved brass bolts of certain size and strength. Seller (not depicted in FIG. 6), another DVN member heretofore unknown to Buyer, manufactures such bolts. An agent/user at Buyer 610 searches the DVN for businesses offering FAA-approved brass bolts. The user accesses the “Search DVN” page through the web browser. The user enters the relevant criteria 612 and initiates a search. The DVN search agent creates a “respond with search results” XML document 622. This document is broadcast over the XML bus to all BNADs 304 currently on-line.

As each BNAD receives the search, its company profile manager element evaluates the requested information and formulates a response based on matches in requested fields. One such BNAD 304B belongs to Seller. Seller's BNAD evaluates the search 634 and decides that a match exists. Seller's profile manager responds by generating a “search results” XML document and sends the document back to Buyer's search agent over the XML bus. Other company profile managers that fail to match the search criteria do not send back responses 636. Because of the ensured network connection and uniformity of information across the DVN, Buyer is certain that Buyer's search has appraised every DVN member's information.

Buyer's search agent receives the “search results” XML documents from each matching member firm 624. The search agent sends the documents as instant messages to Buyer's user through the communications switchboard. The search results appear as an instant message viewed through the user's instant communicator. Buyer reviews the search results 614 and discovers Seller. Buyer can now contact Seller and the parties can begin negotiation of a purchase contract.

No human aspect of Seller's enterprise is involved in the above example; business-critical level of service provision facilitates network-wide communication and the BNAD presents member data in a uniform and searchable format. While the foregoing example has been presented from the perspective of the buyer of goods, it should be apparent that the seller can readily employ the DVN searching feature in a similar manner.

### Example #4

### Setting up a New Partnership

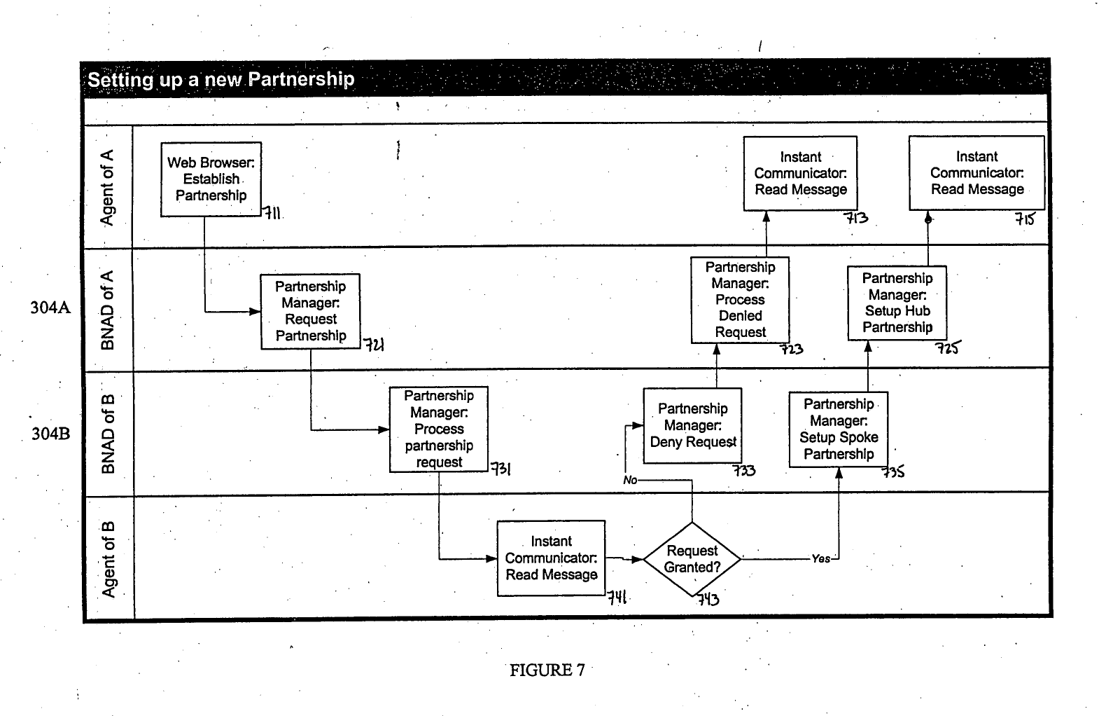

Businesses can also decide that they will form a partnership, e.g., exchanging sales and purchase orders (FIG. 7). A user in Buyer's company can click on or drag-and-drop Seller's company into a partnership box to enter a partnership arrangement. The term “partner” is used broadly here to cover a wide range of relationships, e.g., buyer-seller or principal-agent, or co-marketers, as well as partners in the narrower legal sense. Note that the roles of the users, and not the users' individual identities, define the actors establishing the partnership. In this way, continuity is maintained relative to the transaction notwithstanding the turnover in member personnel and duties.

To continue the above example, Buyer's human agent performs a drag-and-drop action 711 to form a partnership with Seller's product agent. At this point, the partnership management element 543 is invoked.

Buyer's partnership manager 543 receives the partnership formation request. The partnership manager validates 721 the requesting user's authority to form the partnership; if the requesting role is so authorized, a “partnership request” XML document is created. This document is sent via guaranteed delivery on the XML bus to Seller's partnership manager component.

After Seller's partnership manager element receives 731 the partnership request document, it identifies the appropriate role with partnership-granting authority within Seller's hierarchy and forwards the request to that user via the instant communicator. The human user with partnership-granting authority retrieves the XML request document from the instant communicator 741. This user then considers the request and makes a decision 743 whether or not to agree to the partnership. If Seller's agent declines the request, a “partnership-denied” XML document is generated 733 and returned to Buyer's partnership manager component 723 via guaranteed delivery on the XML bus. Buyer's partnership manager passes the “partnership-denied” XML document to the requesting user's instant communicator mailbox 713. The requesting agent/user retrieves the rejection and presumably then pursues another potential partner or tries again, taking a different approach.

If Seller accepts the partnership request, its partnership manager forms a “partnership-established” XML document 735. This document is transmitted to the requesting partnership manager 725 via guaranteed delivery on the XML bus for Buyer's agent's review 715.

Assuming Seller's authorized user accepts the partnership request, both Buyer and Seller's partnership managers interpret Seller's approval, register the partnership and proceed to form the Buyer-Seller partnership at the software level. Shared storage areas are established through the LDAP and all the necessary settings are made to establish a partnership relationship. The firewalls are modified to allow access between the two companies to permit pertinent information to be shared between them. The VPN is configured to define a virtual private network between Buyer and Seller such that only Buyer and Seller can see that traffic, and no one else. The businesses trade public keys, and Buyer and Seller can now transact business between themselves in a secure fashion over the XML bus. All of these arrangements, moreover, have been effected by Buyer's and Seller's simple keystrokes. Neither member business requires specialized network administration personnel to conduct this partnership formation process.

Buyer's partnership manager passes the “partnership established” XML document to the requesting user, who retrieves and reads the message from the instant communicator.

Without this business exchange, a company would have to go through numerous machinations to achieve the same result. The company would have to inform their information services department of this new partnership, contact the other company's IS department, arrive at a mutually agreeable VPN solution, have network engineers describe the machine-to-machine connections, determine the software to be implemented and described in the firewall, and have programmers write an application that would exchange information between these two companies. This process takes weeks or months. In contrast, the present invention performs this same process in minutes by pointing and clicking.

### Example #5

### Transacting with a Partner

The negotiations are done initially through an instant communicator 422, ie., an e-mail facility provided in or alongside the user's browser 420. The contract negotiations travel through the non-repudiable transaction manager, resident in the DVN BENA. Each sender encrypts the documents transmitted, using the recipient's public key; the parties had previously exchanged them. Similarly to partnership formation, the DVN views transactions as being conducted between roles rather than individuals. In this discussion, these roles are referred to simply as “buyer” and “seller.” In the following example, the seller has initiated the transaction by responding to a potential buyer's inquiry with a sale contract offer. However, it could easily be the buyer who initiates a transaction with a purchase offer in response to a potential seller's inquiry.

The seller initiates 811 the transaction by selecting an XML form, such as a contract, or creates one using the forms toolkit. The required information is supplied, and the seller selects the appropriate recipient role within the partner company. The form is tagged 821 with three separate digital certificates, one each for the seller's company, the transacting role and the transacting individual. The form is then sent to the buyer via the guaranteed delivery of the XML bus. Because of the specific type of document, the outgoing message is simultaneously logged 822 in permanent storage by the non-repudiable transaction manager component 544A in the seller's BNAD 304A.

A copy of the document is automatically sent 831 to the BENA, where it is archived 832. The non-repudiable transaction manager 416 of the BENA 301 acts as a neutral body in the negotiations. The transaction manager is an additional recipient of the document, based again on the document identity. Because it is encrypted, the transaction manager serves merely an archival role. Throughout the negotiations, the non-repudiable transaction manager will continue to be a recipient and curator of communications. After contract formation, the parties may agree or barter to change the terms or other provisions of the bargain. Whenever the transaction terms are altered, the BENA is also alerted and receives those further communications for archiving.

The buyer's BNAD 304B receives the XML form document 841. Based on its classification as a transaction document, the buyer's non-repudiable transaction manager logs a copy into permanent storage 842. The buyer's role manager follows the XML instructions and routes the document to the appropriate recipient by role 851. The user is notified via the instant communicator of the form's arrival. The user views the form by decrypting it. Decryption is possible because of the PKI exchange incident to partnership formation. The buyer determines 853 whether the offered terms are acceptable and furnishes any required information of the buyer.

The user accepts the form by applying a personal digital certificate/signature. Additionally, the form is tagged 843 with the seller's company, user and role certificates for tracking and authentication. If the user rejects the offer 845, the form is returned to the sender with optional comments. Upon transmission by the buyer, the buyer's non-repudiable transaction manager logs the transaction in permanent storage 844, 846 and returns the document to the originating role with the buyer using the guaranteed delivery of the XML bus. Because of the document's transactional character, the BENA also receives 831 and archives 832 a copy.

The buyer's BNAD 304A receives the transaction 823, 825; the non-repudiable transaction manager logs it into permanent storage 824, 826 and the role manager passes it to the appropriate user (one serving in the target role). The transacting buyer is notified via the instant communicator of the form's arrival 813, 815. The buyer's PKI, configured previously by the partnership manager, enables the buyer to read a document encrypted by the seller. If rejected, the buyer reviews the form, notes any changes made or proposed, and responds appropriately. If the offer has been accepted, the parties have electronically transacted a contract with the negotiating history archived at both sites as well as with the neutral BENA.

A person skilled in the art will be able to practice the present invention in view of the present description, where numerous details have been set forth in order to provide a more thorough understanding of the invention. In other instances, well-known features have not been described in detail in order not to obscure unnecessarily the invention.

Having described and illustrated the principles of the invention in a preferred embodiment thereof, it should be apparent that the invention can be modified in arrangement and detail without departing from such principles. Although the foregoing description has described the preferred embodiment, it is foreseeable that an element of the invention may be improved in the future. Such improvements are especially likely in the software components of the present invention. I claim all modifications and variations, including those involving the substitution of an improved element which performs substantially the same function, coming within the spirit and scope of the following claims.

1-7. (canceled)

8. A network access device facilitating access by a network member to a dynamic virtual network, the device comprising:
a global network interface accessible to the network member and the dynamic virtual network; and
a processor and memory containing:
software means for identifying the network member to a network authority;
information describing the network; and
software means for the contemporaneous archiving of transaction communications.

9. A device facilitating access to a dynamic virtual network as claimed in claim 8, where the software means for identifying the network member utilizes digital certificates.

10. A device facilitating access to a dynamic virtual network as claimed in claim 8, wherein the information describing the network member includes a subset of commercial and personnel data describing a member.

11. A device facilitating access to a dynamic virtual network as claimed in claim 8, further comprising software means for accessing and searching, over the global network, at least a first directory of information describing the network member.

12. A device facilitating access to a dynamic virtual network as claimed in claim 8, further including software for translating text into an extensible markup language and displaying software for displaying a document coded in extensible markup language to a user.

13. A device facilitating access to a dynamic virtual network as claimed in claim 8, further comprising software means for modifying and storing the member's company profile information.

14. A device facilitating access to a dynamic virtual network as claimed in claim 8, further comprising software means for modifying and storing the member's user profile information.

15. A device facilitating access to a dynamic virtual network as claimed in claim 8, further comprising software means for modifying and storing the member's role information.

16. A device facilitating access to a dynamic virtual network as claimed in claim 8, including means for enabling limited access to the member's information to other network members.

17. A device facilitating access to a dynamic virtual network as claimed in claim 16, in which the network access device includes means for publishing selected company information to other network members while excluding access by network non-members.

18. A method for subscribing a prospective network member to a dynamic virtual network, the method comprising:
providing information regarding the prospective network member to a network authority;
qualifying by the network authority the prospective network member; and
issuing by the network authority network access capability to the prospective network member.

19. A method for subscribing a prospective network member to a dynamic virtual network as claimed in claim 18, wherein the qualifying step includes verification of the provided information with third-party information.

20. The method as claimed in claim 18, wherein the provided information includes at least a first financial datum of the prospective network member.

21. The method as claimed in claim 18, wherein the provided information includes at least a first personnel datum of the prospective network member.

22. The method as claimed in claim 18, wherein the provided information consists of general business entity data of the prospective network member.

23. A method for subscribing a prospective network member to a dynamic virtual network as claimed in claim 18, further comprising the steps of:
connecting the prospective network member to the network; and
confirming by the network authority the veracity of the prospective network member's network access information.

24. A method for subscribing a prospective network member to a dynamic virtual network as claimed in claim 18, wherein the network access capability is facilitated by a network access device, the network access device limiting dynamic virtual network access to subscribed network members.

25. A method for subscribing a prospective network member to a dynamic virtual network as claimed in claim 18, wherein the network access capability includes assignment of at least a first digital certificate to the new network member.

26. A method for subscribing a prospective network member to a dynamic virtual network as claimed in claim 18, where the network access capability includes assignment of at least one internet protocol address.

27. A method for subscribing a prospective network member to a dynamic virtual network as claimed in claim 23, wherein the confirmation step includes verification of at least the first certificate assigned to the network member.

28-47. (canceled)

48. A method for the presentation over a network of information belonging to a plurality of disparate users of the network, wherein the information is searchable using a single search query, the method comprising;
creating a database capable of being connected to the network;
collecting information from a first network user;
inputting information for the first network user into the database utilizing a data structure;
collecting information from a second network user; and
inputting information for the second network user into the database utilizing the same data structure.

49. The method for the presentation over a network of information as claimed in claim 48, wherein the database exists in two or more at least partly unique subsets and wherein at least one of the partly unique subsets resides in the memory of a computer separate from the other subsets of the database.

50. The method of claim 18, wherein the issuing step comprises customizing a network access device by the network authority and issuing the customized network access device to the prospective network member.
